(19) United States
(12) Patent Application Publication
(10) Pub. No.: US 2002/0161634 A1
(43) Pub. Date: Oct. 31, 2002

(54) Electronic document with an automatically updated portion

(75) Inventor: Peter Bernhard Kaars, Cupertino, CA (US)

Correspondence Address: Corporate Patent Cousel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/844,786

(22) Filed: Apr. 27, 2001

(51) Int. Cl. G06F 17/60

(52) U.S. Cl. 705/14; 707/526

(57) ABSTRACT

A method is provided enabling an individual to temporarily control the display of an electronic document. A portion of the document is automatically updated and modified while displayed without the user being in control of the change. When a specific content information is displayed in the portion, the method allows the individual to request the display in the portion of another content information in lieu of the specific content information. The other content information may be displayed for a predetermined period of time.

### FIELD OF THE INVENTION

The invention relates to a method of enabling the display of an electronic document with a portion of the document being automatically updated while displayed.

The invention also relates to an apparatus for enabling the display of an electronic document with a portion of the document being automatically updated while displayed. The invention further relates to such an electronic document and to a portion for embedding in an electronic document.

The invention also relates to a computer readable storage medium for storing a set of instructions for carrying out a method of the invention.

### BACKGROUND ART

A great portion of the revenue stream of Internet-based companies originates from advertisements made on their Web sites. Advertisements are in the form of banners in reserved spaces on Web pages. An advertisement on a Web page may be updated whenever the user requests the page again or refreshes the page. The advertisement can be targeted to the user requesting the Web page using information from cookies stored on the user's personal computer. In some instances, an advertisement can also be changed while actually being displayed. Indeed, an advertisement in a Web page may also be updated and refreshed independently of the user requesting it. This is possibly done using the well-known Webcasting technology or push technology. In the push technology, a Web server pushes information to the user rather than waiting for the user to specifically request it. This technology requires a piece of software to be installed in the user's browser for initiating the new advertisement. Another way of modifying a portion of a Web page is to insert specific instructions in the HTML code of the Web page to have the browser automatically contact the Web server and refresh the portion when a period of time elapses. Thus, several techniques already exist to permit the automatic modification of a portion of a Web page independently of any user request.

In a set top box environment, similar techniques exist to automatically update a portion of the graphical electronic program guide (EPG) presented to the user. This portion of the EPG, for example, displays national or local advertisements. A selection of advertisements is stored in a memory of the set-top box and these advertisements are sequentially displayed until the selection is updated with new advertisements, e.g. daily or weekly when the set top box connects to the server of the service provider.

### SUMMARY OF THE INVENTION

It is an object of the invention to allow an individual to browse back to a content information that was previously displayed to the individual and that disappeared without the individual's intervention.

It is another object of the invention to provide efficient information distribution.

To this end, a method of the invention comprises:

causing a display of a first content information in the portion; and,

enabling an individual to request a display of a second previously displayed content information in lieu of the first content information.

Such a method allows an individual to freely browse content information displayed to him and modified without his intervention. Thus, if a piece of content information relevant to the individual suddenly disappears, the invention allows the individual to go back and retrieve the relevant information. An advantage of the invention is to allow the individual to momentarily take control over the display of content information in a portion being continuously and automatically updated. Another advantage of one or more embodiments of the invention is to allow efficient advertising and efficient information distribution.

Further an apparatus of the invention comprises:

storage means for storing at least a first and a second content information; and,

controlling means for causing a display of the second content information in the portion, for, thereafter, causing a display of the first content information in the portion, and, for, upon request, causing a display of the second content information in lieu of the first content information.

Such an apparatus of the invention allows the user to take momentary control over the display of content information in the portion. Such an apparatus may be a set-top box used for receiving interactive services from a cable operator. The cable operator may sublet this portion as an advertisement space. The service provider may also use the portion to display information on channel programs or to advertise ancillary services offered by the cable operator or other service providers such as email, interactive games, personalized audio entertainment, etc. . . . The apparatus may also be a personal computer that temporarily caches the second content information so that it can be retrieved if the user requests to have it re-displayed in lieu of the first content information.

### BRIEF DESCRIPTION OF THE DRAWINGS

The invention is explained in further detail, by way of example, and with reference to the accompanying drawing wherein:

FIG. 1 is a flow-chart diagram of a method of the invention;

FIG. 2 is a communication system over the Internet; and, FIG. 3 is a document of the invention over time.

### PREFERRED EMBODIMENT

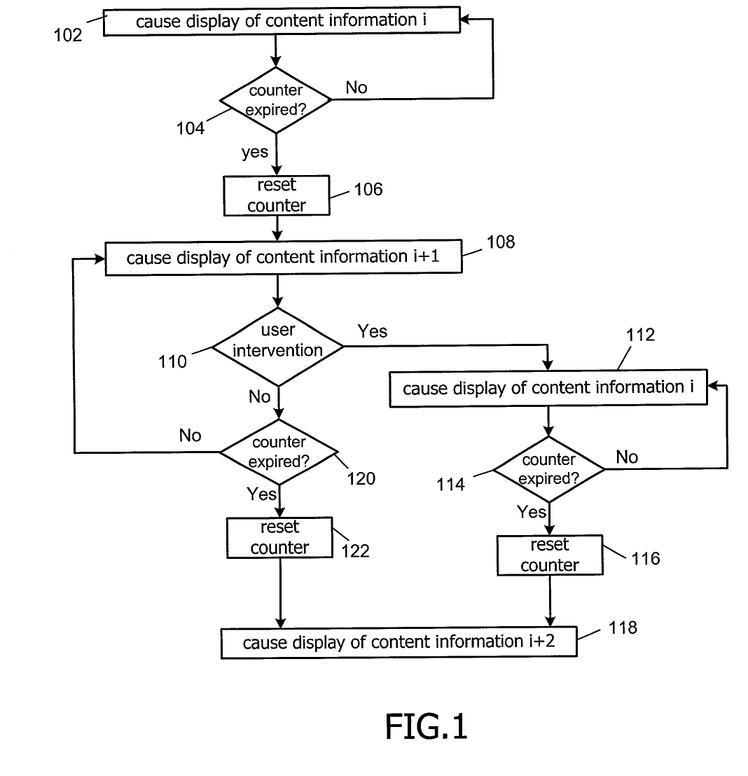

FIG. 1 is a flow-chart diagram of a method of the invention. The invention relates to the display of an electronic document to an individual. The document may be, e.g. a Web page on the Internet, a piece of content information like a portion of an electronic program guide (EPG) sent by a provider, e.g. a cable operator, TV station, TV network, etc. . . . , received as part of a personal television service. The document may also be any other type of electronic document, such as a train schedule, a city guide and the like, displayed by kiosks for providing general information to individuals in public locations. This is by no means a limitation of the invention and any type of electronic content may be considered. In the invention, the document comprises a portion, which is automatically updated. As used herein “automatically updated” indicates that the content information being displayed in the portion is automatically changed while the portion is displayed. The change in the content information is automatic as it is not controlled and requested by the user. The content information may be updated on a regular basis or modified upon action by the provider of the document. The portion can be used to display advertisements for products or services. The portion may also be used to provide updates or notifications as to subjects of interest to the individual such as stock quotes, weather, news, sports etc. . . . In the context of the Internet, the portion may allow flash animations or may allow rendering a Javascript application.

In a method of the invention, a first step 102 comprises causing the display of the content information i in said portion of the electronic document. Simultaneously, a counter is reset and activated. In this embodiment, the portion is modified on a timely basis and the counter counts the time a given piece of content information is displayed in the portion. Thus, content information i is displayed until the counter expires in step 104. The counter is configured to reset automatically after a predetermined period of time in step 106. In step 108, content information i+1 is displayed in the portion thereby replacing content information i. The counter was reset in step 106 and counts the time during which content information i+1 is displayed.

In a third step 110, a user intervention may be detected. Indeed, in the invention, the user may request the display of a piece of content information that was previously displayed in the portion. The user may override the automatic change of the content information displayed in the portion. For example, the user selects a back arrow icon on the document. The icon is a user interface element associated with the portion and selection of the icon triggers a request for the content information that was previously displayed in the portion, content information i in this embodiment. Alternatively, the document comprises a menu icon that upon selection or mouse-over opens an interactive list of content information that were previously displayed in the portion. The user can browse the list and choose the one that he wants to have temporarily re-displayed in the portion. The user may also request to go back to content information i using a remote control or any other control device. Indeed, the display of the document and specifically the display of the portion may be configured to be controlled in response to commands incoming from the control device. In an embodiment of the invention, content information i is re-displayed in step 112, in response to the user request in step 110, until the counter has expired in step 114. When the counter expires in step 114, the counter automatically resets in step 116. Thereafter, in step 118, new content information i+2 is automatically displayed in the portion thereby replacing content information i and the counter resets in step 112. Alternatively, content information i is temporarily re-displayed for a pre-configured limited period of time as the user requested it. After this limited period of time, the display of content information in the portion goes back to its normal process. Thus, after a few seconds for example, content information i+1 is re-displayed in the portion as it was before the user requested to go back to content information i. Content information i+1 continues to be displayed for the time remaining in the counter until the display changes again to content information i+2 in step 118.

If no user intervention is detected in step 110, content information i+1 is displayed until the counter expires in step 120. Then the counter resets automatically in step 122 and content information i+2 is displayed in step 118.

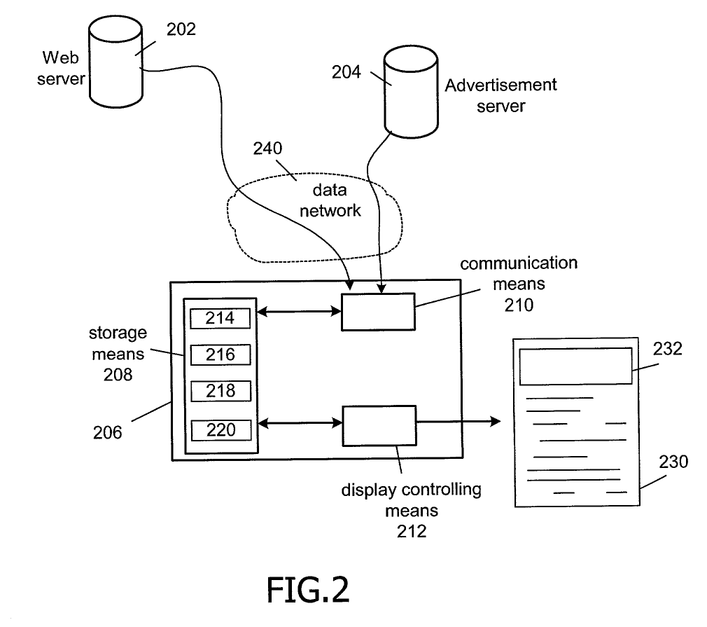

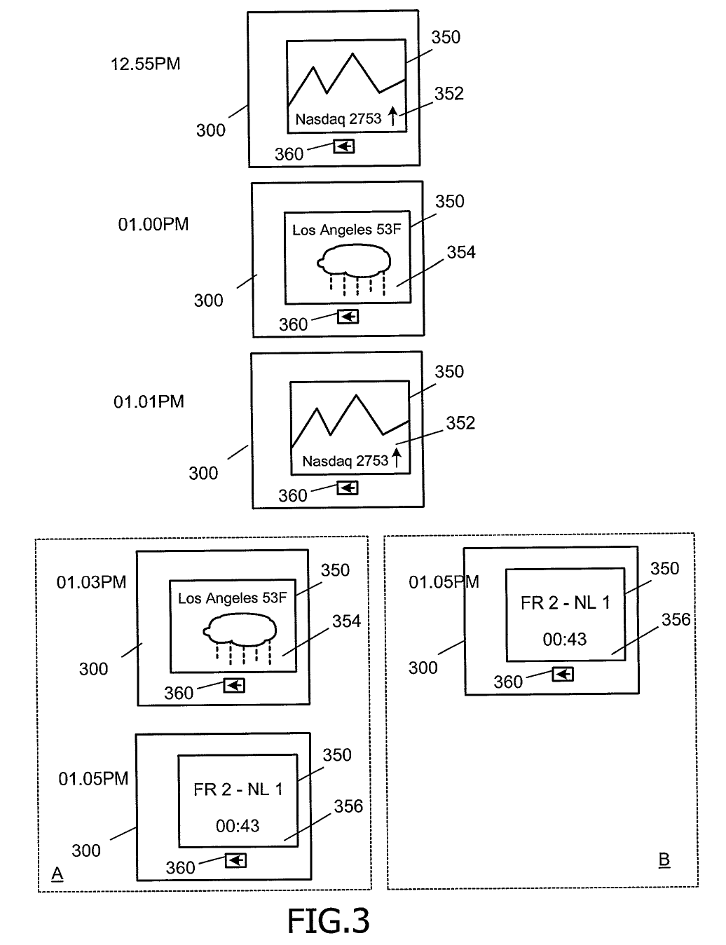

FIG. 2 is an embodiment of a system 200 comprising an apparatus 206 of the invention communicating over a data network 240 with a Web server 202 and an advertisement server 204. The apparatus 206 comprises storage means 208, communication means 210 and controlling means 212. The communication means 210 allows the apparatus 206 to communicate over the network 240 with other devices including the Web server 202 and the advertisement server 204. Devices may communicate over the network 240 using terrestrial cable, phone lines, optical communication means or satellites. The communication means 210 comprises a modem or any other dialing system for transmitting and receiving data over the network 240. The Web server 202 delivers content information, e.g. Web pages to clients such as the apparatus 206. The advertisement server 204 delivers advertisements to be inserted in Web pages received from the Web server 202.

In this embodiment, the Web server 202 transmits a specific Web page 230 to the apparatus 206 in response to a previous request. The apparatus 206 is configured to enable the display of the Web page 230 to a user. The Web page 230 comprises a portion 232 displaying advertisements. In another embodiment, the portion 232 may be used for the display of content information other than advertisements. The portion 232 is automatically updated and a new advertisement is regularly displayed in the portion 232 replacing the previous one without the user requesting it. The Web page 230 is an HTML file constructed as a juxtaposition of multiple Web frames. A Web frame is an independently controllable section on the Web page. The Web page 230 is therefore constructed as separate HTML files, the frames, retrieved together when the URL of the page 230 is requested. The portion 232 corresponds to one of the frames in the HTML file of the Web page 230. This frame may be written such that the advertisement displayed in the portion 232 is updated every 15 seconds for example. To this end, when the browser or any proper software application present in the apparatus 206 executes the HTML code of the Web page 230 and specifically renders the HTML code in the frame associated with the portion 232, the communication means 210 contacts the advertisement server 204 every 15 seconds for a new advertisement. Such a software application may be in the display controlling means 212. In this embodiment of the invention, advertisements 220, 218 and 216 were previously received from the advertisement server 204 and displayed in the portion 232. The advertisements 216-220 are stored in the storage means 208 being used as a temporary memory. The storage means may be a solid state memory, a hard-disk drive, a magnetic or optical drive or an optical disk. The storage means 208 may also store respective URLs that uniquely identify the advertisements 216-220 at the advertisement server 204. An advertisement 214 was also previously received from the server 204 and is currently displayed in the portion 232. The advertisement 214 is stored in storage means 208.

The controlling means 212 allows the user viewing the Web page 230 to modify the content information displayed in the portion 232. Indeed, the user is enabled to go back to an advertisement previously displayed in the portion 232. In this embodiment, the user can request the display of one of the advertisements 216-220 stored in the storage means 208. It is also within the scope of the invention that the storage means 208 can store a greater number of advertisements. The display controlling means 212 of the invention retrieves the requested advertisement 216, 218 or 220 from the storage means 208 and replaces the advertisement 214 currently displayed by the requested advertisement 216, 218 or 220.

Alternatively, the display controlling means 212 may allow browsing through the advertisements 214-220. For example, the portion 232 may have a horizontal scrolling bar that permits continuous scrolling through respective representative images of the advertisements 214-220. The user uses the scrolling bar to browse through the advertisements 214-220 and stops at the desired advertisement.

In another embodiment, the apparatus 206 is a set top box configured to receive a data service from a service provider. The set top box receives interactive services, e.g. a personal television service, from the service provider. As part of these interactive services, an EPG is transmitted to the box. This EPG is regularly updated and reloaded onto the box. The EPG can be displayed to the user and allows the user to browse through entertainment programs that channels have scheduled to broadcast for a given period of time. The EPG allows the user to select a program or channel for watching, recording or rating. The EPG may also permit the user to access and use additional digital entertainment services such as chat room, email, news reports, personalized radio, digital music files, etc. . . . . The EPG is the principal communication interface with the user and as a result often comprises a reserved area for displaying advertisements. In this embodiment, these advertisements are stored in a local memory in the apparatus and sequentially displayed to the user. The display of advertisements on the EPG is updated automatically without the user requesting it while the EPG is displayed. In some instances, the display of the advertisements is modified as a result of an action of the user, e.g. in response to a control command from the user such as lowering the volume. To that respect, reference is made to U.S. Pat. No. 5,233,423 herein incorporated by reference. In this document a television receiver is equipped with a graphics generator which is capable of generating a single or multiple graphic images from data representing commercial advertisements stored in a memory device. The images corresponding to the commercial advertisements are displayed to the consumer when a control function of the television receiver is activated. Alternatively the images may be displayed in response to an internal clock.

According to the invention, the set-top box allows the user to request to display again an advertisement that was previously displayed in the reserved portion of the EPG.

FIG. 3 depicts the evolution of a displayed document 300 of the invention with time. The document 300 comprises a portion 350 where content information is displayed to a user and automatically updated. A service may be proposed to an Internet user to display content information of his choice. For example, an additional window is opened on top of the application or the Web page currently viewed by the user and in this window, the service provider allows to display updates or news that the user wanted to be informed of as part of the data service. Thus, the window is an independent document and the portion is part of this window or possibly the entire window. Alternatively, the window is inserted in the document 300 currently displayed to the user.

In this embodiment, the document 300 is configured so that the content information displayed in the portion 350 varies automatically every 15 seconds. The user has chosen to have three different content information 352, 354 and 356 sequentially displayed in the portion 350. For example as shown in FIG. 3, at 12.55 pm the portion 350 displays a content information 352 showing the current value of a given stock market index. The content information 352 may actually be downloaded to the device of the user used to render the document 300 and the content information 352 or the content information 352 maybe streamed to the device of the user. The content information 352 my also be a Flash animation. As a result, the display of the content information 352 may vary over time. At 1.00 pm the portion 350 is automatically updated while being displayed with a new content information 354 showing the current weather in Los Angeles. The update may be triggered by a software application installed on the user device to enable the data service of the service provider. The content information 354 is automatically displayed in lieu of the content information 352.

The document 300 further comprises a user interface element 360 represented as a back arrow icon. The element 360 allows the user to request to have the content information previously displayed in the portion 350 temporarily redisplayed in the portion 350. At 01.01 pm the user selects the element 360 to request the display of content information 352 that was displayed just before content information 354. The user may have missed the display of content information 352 and desires to have it back for a few moments. In a first scenario depicted by A in FIG. 3, the display of the document 300 is configured so that the content information 352 is re-displayed for a predetermined period of time, two minutes and thereafter, at 1.03 pm, the content information 354 for which the display was interrupted when the user requested to go back to content information 352, is displayed again in the portion 350. Then, at 1.05 pm the content information 354 displayed in the portion 350 is updated to a content information 356 giving the current score of a soccer game and for how long the game has been played. The display in the portion 350 is back to its normal process. In a second scenario indicated by B in FIG. 3, the display of the document 300 is configured so that the content information 352 is re-displayed for the time the content information 354 was supposed to be displayed, being four minutes until the portion 350 is automatically updated. At 1.05 pm the portion 350 is automatically updated as part of the data service and the content information 356 is displayed. The display in the portion 350 is back to its normal process.

It is to be noted that, with respect to the described method and apparatus, modifications or improvements may be proposed without departing from the scope of the invention as hereinafter defined by the appended claims and that the invention is thus not limited to the examples provided. For instance, it is clear that this method may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits.

The word “comprising” does not exclude the presence of other elements or steps than those listed in a claim.

I claim:

1. A method of enabling a display of an electronic document with a portion being automatically updated while being displayed, the method comprising:
causing a display of a first content information in the portion; and,
enabling an individual to request a display of a second previously displayed content information in lieu of the first content information.

2. The method of claim 1, wherein the first and second content information comprise advertisements.

3. The method of claim 1, wherein the document comprises a selectable graphical user interface element that, upon selection, triggers a request for the display of the second content information.

4. The method of claim 1, further comprising:
causing the temporary display of the second content information in the portion.

5. An apparatus for enabling the display of an electronic document with a portion of the document being automatically updated while being displayed:
storage means for storing at least a first and a second content information; and,
controlling means for causing a display of the second content information in the portion, for, thereafter, causing a display of the first content information in the portion, and, for, upon request, causing a display of the second content information in lieu of the first content information.

6. The display apparatus of claim 5, wherein the apparatus comprises a set top box.

7. An electronic document comprising:
a portion being automatically updated while displayed, the portion displaying a first content information and the portion being configured to display a second previously displayed content information in lieu of the first content information in response to a control command.

8. The electronic document of claim 7, further comprising:
a selectable user interface element that, upon selection, triggers the control command.

9. The electronic document of claim 7, wherein the control command is received from a separate control device.

10. The electronic document of claim 7, wherein the first and second content information comprise advertisements.

11. The electronic document of claim 7, wherein the first and second content information are selected by the individual.

12. The electronic document of claim 7, wherein the document comprises an electronic program guide.

13. The electronic document of claim 7, wherein the document comprises a Web page and the portion is a Web frame.

14. A computer readable storage medium for storing instructions for carrying out a method of displaying a document with a portion of the document being automatically updated while being displayed, the method comprising:
causing a display of a first content information in the portion; and,
enabling an individual to request a display of a previously displayed second content information in lieu of the first content information.

15. A method of enabling to display an electronic document with a portion whose content is automatically changed while the document is being displayed, the method comprising enabling an end-user to override the automatic change.

16. The method of claim 15, wherein the enabling to override comprises enabling to cause the portion to display the content displayed on a previous occasion.

17. A portion for embedding in an electronic document, the portion displaying content that is automatically changed while the document is being displayed, the portion comprising means to enable an end-user to override the automatic change.

18. A control software for use in a portion for embedding in an electronic document, the portion displaying content that is automatically changed while the document is being displayed, the portion comprising means to enable an end-user to override the automatic change.
